(19) United States
(12) Patent Application Publication
(10) Pub. No.: US 2011/0107572 A1
(43) Pub. Date: May 12, 2011

(54) DEVICE AND METHOD FOR PRODUCING FUNCTIONAL POCKET SPRING MATTRESS, AND MATTRESS PRODUCED THEREBY

(76) Inventor: Deok Nam KIM, Seoul (KR)

(21) Appl. No.: 12/941,142

(22) Filed: Nov. 8, 2010

(30) Foreign Application Priority Data
Nov. 9, 2009 (KR) 10-2009-0107481

(51) Int. Cl. B68G 7/00

(52) U.S. Cl. 29/91.1; 29/91

(57) ABSTRACT

A device and method for producing functional pocket spring mattresses, and a mattress produced by the method, in which a predetermined number of pocket springs each prepared by connecting a predetermined number of pocket spring units to each other in the form of a band are arrayed to fit a bed mattress of a desired predetermined size.

### BACKGROUND OF THE INVENTION

1. Field of the Invention

The present invention relates, in general, to a device and method for producing functional pocket spring mattresses, and a mattress produced by the method and, more particularly, to a device and method for producing functional pocket spring mattresses, and a mattress produced by the method, in which a predetermined number of pocket springs each prepared by connecting a predetermined number of pocket spring units to each other in the form of a band are arrayed to fit a bed mattress of the desired predetermined size.

2. Description of the Related Art

Generally, to produce a conventional bed mattress, a plurality of coil springs are coupled to each other in the lateral and longitudinal directions, thus forming an integrated coil string structure capable of providing uniform cushion effects and/or uniform cushioning performances over different areas of the mattress.

However, different parts having different weights of a user's body impose different pressure on associated areas of the mattress, so that, when a user is laying on a mattress that has uniform cushioning performance, areas of the mattress corresponding to heavy parts of the user's body are excessively pressurized, thus failing to efficiently support the waist or the neck of the user's body and thereby causing them to bend. Therefore, the user of the mattress cannot fall asleep easily or enjoy a comfortable sleep and thereby may not be easily released from fatigue. Further, because the user of the mattress may adopt an uncomfortable posture on the mattress for a lengthy period of time, the user may suffer from diseases, such as disc problems in the back.

Further, in the related art, pocket springs used in bed mattresses are covered with covers, such as unwoven fabrics, one by one such that the pocket springs are isolated from each other. Generally, the pocket springs have been produced in the form of a band, in which pocket spring units are connected to each other.

Therefore, to produce a bed mattress using the pocket springs, the pocket springs, which have been produced such that the pocket spring units are arranged at large intervals between them, must be adjusted in the intervals between the pocket spring units so as to fit a predetermined size of a desired mattress. However, this method is problematic in that the positions of the pocket spring units are not regular.

Further, in a conventional process for producing a functional bed mattress using the pocket springs, independent pocket spring units having different cushioning performance must be manually set to form a desired functional mattress, thus failing to realize an efficient process. Further, in the completely produced mattress, the pocket spring units are spaced apart from each other by excessively wide intervals, so that it is almost impossible to realize the desired cushion effect in the space between the pocket spring units. Therefore, the pocket springs may not efficiently support a user's body while the user sleeps on the mattress, and thereby the upper surface of the mattress may become depressed.

### SUMMARY OF THE INVENTION

Accordingly, the present invention has been made keeping in mind the above problems occurring in the related art, and the present invention is intended to propose a device and method for producing functional pocket spring mattresses, and a mattress produced by the method, in which a predetermined number of pocket springs each prepared by connecting a predetermined number of pocket spring units to each other in the form of a band are arrayed to fit a predetermined size of a desired bed mattress.

In order to achieve the above object, according to one aspect of the present invention, there is provided a device for producing functional pocket spring mattresses, in which a predetermined number of pocket springs each prepared by connecting a predetermined number of pocket spring units to each other in the form of a band are arrayed to fit a predetermined size of a desired bed mattress, the pocket spring mattress producing device including: a supply unit for supplying the pocket springs; a transfer unit for transferring the pocket springs supplied by the supply unit; and a setting unit for setting the pocket springs transferred by the transfer unit, thus producing a functional pocket spring mattress.

The supply unit may include: a toothed drum having a plurality of holding grooves for holding the pocket springs; a drive unit for rotating the drum; a first feeding unit for feeding the pocket springs supplied by the drum; and a second feeding unit for feeding the pocket springs held on the first feeding unit in a direction perpendicular to a moving direction of the first feeding unit.

The transfer unit may include: a transfer body having shafts in opposite ends thereof and a plurality of tongs for holding the pocket springs, each of the shafts being held by a bearing installed on an upper surface of a bracket; a rack and a pinion provided at locations around an end of one of the shafts of the transfer body such that the transfer body can be rotated in response to vertical movement of the rack, the rack being combined at a lower end thereof with a pneumatic cylinder; a reciprocator for moving the transfer body to the left and right, the reciprocator being provided at a location outside the ends of the shafts of the transfer body and having a belt wrapped around belt pulleys; and a pneumatic cylinder installed at a location above the bracket and moving the transfer body upwards and downwards.

The transfer body may further include: a first pneumatic cylinder for actuating the tongs; and a push plate provided at a location inside the tongs such that the push plate can push the pocket springs held by the tongs into the setting unit, the push plate being actuated by a second pneumatic cylinder.

The setting unit may include: a layering unit for supplying and adhering layering covers to upper and lower surfaces of the pocket springs transferred by the transfer unit; a spraying unit for spraying the adhesive agent both onto the layering covers and to the pocket springs such that the layering covers supplied from the layering unit can be adhered to the upper and lower surfaces of the pocket springs transferred by the transfer unit, and right ends of the existing pocket springs can be adhered to left ends of next pocket springs newly transferred by the transfer unit; and a cutting unit for cutting the layering covers at ends of a predetermined number of pocket springs arrayed and adhered to each other by the spraying unit, thus fitting a mattress of a predetermined length.

The layering unit may include: a pair of conveyor belts and a pair of rollers combined with each other into pairs, the pairs of conveyor belts and rollers being actuated by a drive unit such that the pocket springs can be fed to the rollers while being guided by inside parts of the rotating conveyor belts.

The layering unit may further include: a first frame and a second frame having respective conveyor belts and respective rollers on front and rear surfaces thereof, the first and second frames being combined with each other by a screw drive shaft such that an interval between the first and second frames can be adjusted by rotating the screw drive shaft.

The spraying unit may include: a main body for supplying the adhesive agent; a plurality of spray nozzles for spraying the adhesive agent supplied from the main body both to the pocket springs and to the layering covers; and a carrier for carrying the spray nozzles and moving the spray nozzles such that the spray nozzles can spray the adhesive agent onto both upper surfaces of the pocket springs and to upper surfaces of the layering covers in a direction from one end to another end.

The cutting unit may include: a cutter having a blade and installed in a space defined between the conveyor belts and the rollers.

In another aspect, there is provided a method for producing functional pocket spring mattresses, in which a predetermined number of pocket springs each prepared by connecting a predetermined number of pocket spring units to each other in the form of a band are arrayed to fit a predetermined size of a desired bed mattress, the pocket spring mattress producing method including: a pocket spring supplying operation for supplying first and second pocket springs having different spring steel wire diameters using first and second supply units; a transferring operation for transferring the pocket springs supplied in the pocket spring supplying operation; a layering cover supplying operation for supplying layering covers so as to adhere the layering covers to upper and lower surfaces of the pocket springs transferred in the transferring operation; an adhesive agent spraying operation for spraying an adhesive agent both to the pocket springs and to the layering covers supplied in the layering cover supplying operation; a layering operation for adhering the layering covers to the upper and lower surfaces of the pocket springs supplied in the pocket spring supplying operation; and a cutting operation for cutting ends of a predetermined number of pocket springs which have been arrayed in the layering operation and in which the layering covers have been adhered to the upper and lower surfaces of the arrayed pocket springs.

In a further aspect, there is provided a functional pocket spring mattress, in which a predetermined number of pocket springs each prepared by connecting a predetermined number of pocket spring units to each other in the form of a band are arrayed to fit a mattress of a predetermined size, the functional pocket spring mattress including: first and second pocket springs having different spring steel wire diameters and being repeatedly and sequentially set in the mattress.

According to the present invention, a predetermined number of pocket springs each prepared by connecting a predetermined number of pocket spring units to each other in the form of a band can be arrayed to fit a predetermined size of a desired bed mattress, so that functional pocket spring mattresses having a predetermined size can be repeatedly produced.

Further, in the functional pocket spring mattress, two types of pocket springs having different spring steel wire diameters are used in different areas of the mattress on which different parts of a user's body are laid, thus realizing desired cushion effects and desired cushioning performances fitting the parts of the user's body. Therefore, users using the functional pocket spring mattresses can fall asleep easily and can enjoy a comfortable sleep and, further, can receive the benefits of having diseases prevented thanks to waist pain being relieved by the function of the pocket spring mattress.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1 and 2 are a perspective view and a side view illustrating a functional pocket spring mattress producing device according to the first embodiment of the present invention;

FIG. 3 is a plane view illustrating a functional pocket spring mattress produced by the mattress producing device according to the present invention;

FIGS. 4 and 5 are a perspective view and a front view illustrating a functional pocket spring mattress producing device according to the second embodiment of the present invention;

FIG. 6 is a perspective view illustrating the operation of the functional pocket spring mattress producing device according to the second embodiment of the present invention;

FIGS. 7 and 8 are a perspective view and a front view illustrating a transfer unit of the functional pocket spring mattress producing device according to the second embodiment of the present invention;

FIGS. 9A, 9B and 9C are views illustrating the sequential operation of the transfer unit of the functional pocket spring mattress producing device according to the second embodiment of the present invention;

FIGS. 10 and 11 are a perspective view and a plane view illustrating a setting unit of the functional pocket spring mattress producing device according to the second embodiment of the present invention;

FIG. 12 is a view illustrating the operation of a layering unit of the functional pocket spring mattress producing device according to the second embodiment of the present invention;

FIGS. 13 and 14 are a perspective view of a spraying unit of the functional pocket spring mattress producing device according to the second embodiment of the present invention, and a view illustrating the operation of the spraying unit;

FIG. 15 is a view illustrating the operation of a setting unit of the functional pocket spring mattress producing device according to the second embodiment of the present invention;

FIG. 16 is a view illustrating the operation of a cutter of the functional pocket spring mattress producing device according to the second embodiment of the present invention;

FIG. 17 is a front view illustrating a functional pocket spring mattress producing device according to a third embodiment of the present invention;

FIGS. 18 and 19 are views illustrating the operation of a layering unit of the functional pocket spring mattress producing device according to the third embodiment of the present invention; and

FIG. 20 is a block diagram illustrating the process of a functional pocket spring mattress producing method according to the present invention.

### DETAILED DESCRIPTION OF THE INVENTION

Reference will now be made in greater detail to preferred embodiments of the invention, which are illustrated in the accompanying drawings. Wherever possible, the same reference numerals will be used throughout the drawings and the description to refer to the same or like parts.

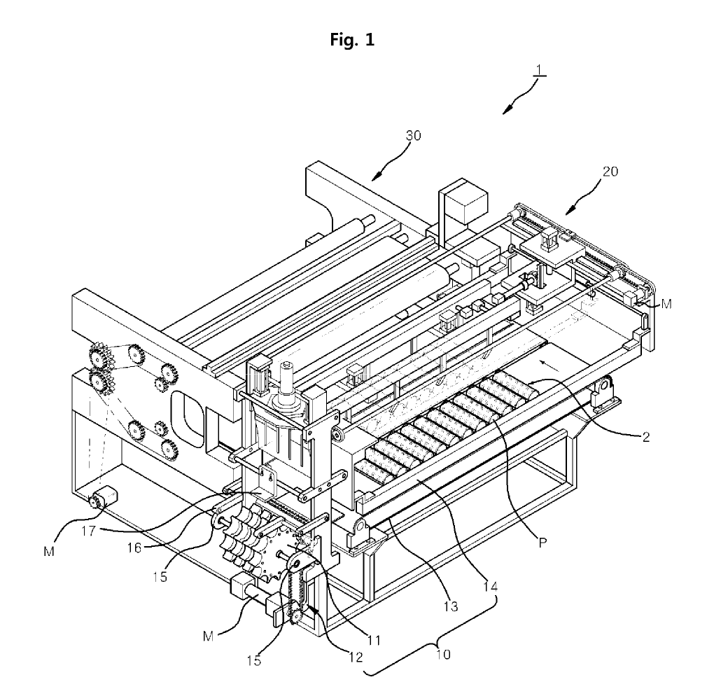

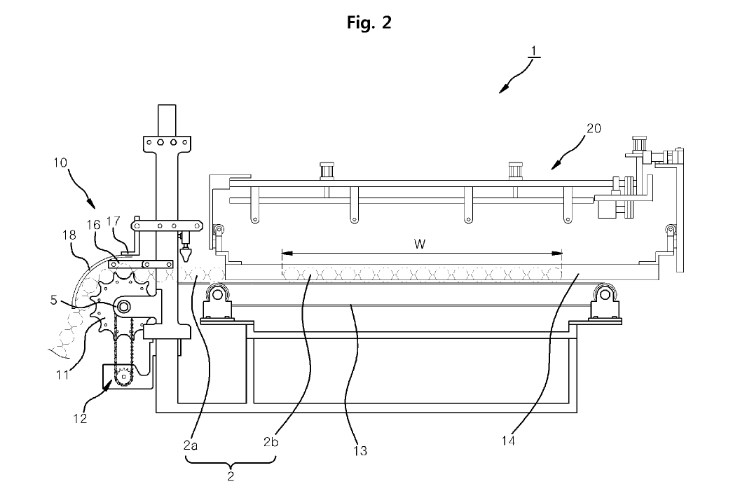

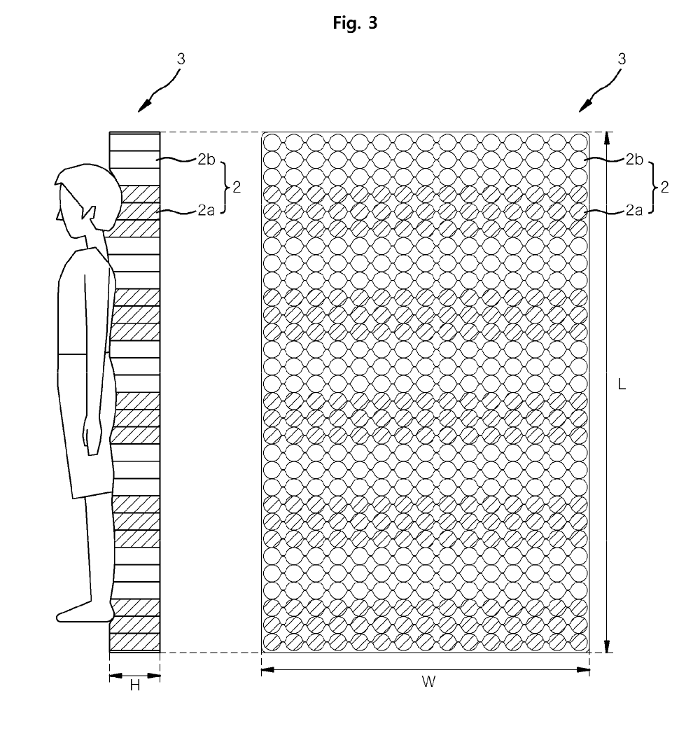

FIGS. 1 and 2 are a perspective view and a side view illustrating a functional pocket spring mattress producing device according to the first embodiment of the present invention. FIG. 3 is a plane view illustrating a functional pocket spring mattress produced by the mattress producing device according to the present invention.

As shown in FIGS. 1 through 3, the functional pocket spring mattress producing device 1 includes a supply unit 10 for supplying pocket springs 2, a transfer unit 20 for transferring the pocket springs 2 supplied from the supply unit 10, and a setting unit 30 for setting the pocket springs 2 transferred by the transfer unit 20 and producing a functional pocket spring mattress 3.

To produce a functional pocket spring mattress, the functional pocket spring mattress producing device 1 is operated as follows. As shown in FIG. 3, when pocket springs 2, each prepared by connecting a predetermined number of pocket spring units P to each other such that each pocket spring forms a predetermined width W of a desired mattress, is supplied from the supply unit 10, the transfer unit 20 transfers the supplied pocket springs 2 to the setting unit 30. Upon receiving the pocket springs 2 from the transfer unit 20, the setting unit 30 sets a predetermined number of pocket springs 2 such that the pocket springs 2 fits a predetermined length L of the mattress, thus producing a desired pocket spring mattress 3.

The supply unit 10 supplies both first pocket springs 2a having a thick spring steel wire and second pocket springs 2b having a thin spring steel wire. Here, the supply unit 10 supplies the first pocket springs 2a to areas of the mattress on which the heavy parts of a user's body, such as the head, the waist and the buttocks, rest.

For other areas of the mattress on which the light parts of the user's body are laid, the supply unit 10 repeatedly and regularly or repeatedly and irregularly supplies one or a plurality of second pocket springs 2b having higher cushion effects or higher cushioning performances than those of the first pocket springs 2a.

Therefore, as shown in FIG. 3, a functional pocket spring mattress 3 having different cushion effects or different cushioning performance over the areas thereof corresponding to the different parts of a user's body can be produced.

The above-mentioned functional pocket spring mattress producing device 1 is preferably designed such that an outer cover, in which the first pocket springs 2a and the second pocket springs 2b form respective pockets, has different colors at locations corresponding to the first and second pocket springs 2a and 2b.

Due to the different colors of the outer cover, the first and second pocket springs 2a and 2b having different spring steel wire diameters can be easily distinguished from each other and the functional pocket spring mattress 3 can have a good appearance, as shown in FIG. 3.

As shown in FIGS. 1 and 2, the supply unit 10 includes a toothed drum 11 having a plurality of holding grooves for holding the respective pocket springs 2, a drive unit 12 for driving the toothed drum 11, a first feeding unit 13 for feeding the pocket springs 2 supplied by the drum 11, and a second feeding unit 14 for feeding the pocket springs 2 held on the first feeding unit 13 in a direction perpendicular to a moving direction of the first feeding unit 13.

Here, the shaft of the drum 11 is held by a support bracket 15 having bearings, and the drive unit 12 is preferably configured such that the gear mounted to the shaft of the drum 11 can be coupled to the gear mounted to the shaft of a drive motor M by a chain and the drum 11 can be rotated by the drive motor M.

The functional pocket spring mattress producing device 1 operates such that the pocket springs 2, each prepared by connecting a predetermined number of pocket spring units P to each other in the form of a band, are supplied by the supply unit 10 and are retained by the respective holding grooves of the drum 11, and are fed to the first feeding unit 13 by the rotations of the drum 11 driven by the drive unit 12.

At locations around the drum 11, side guards 16 and upper guards 17 are provided for guiding the pocket springs 2 such that the pocket springs 2 can be prevented from undesirably diverging or becoming separated from the drum 11. Further, a rounded cover 18 is preferably mounted to the lower end of the upper guard 17 such that the rounded cover 18 can cover the pocket springs 2 held in the respective holding grooves of the drum 11.

Due to the side guard 16, the upper guard 17 and the cover 18 of the functional pocket spring mattress producing device 1, the pocket springs 2 can be stably held on the drum 11 and, after the pocket springs 2 are held on the drum 11, the pocket springs 2 can be stably fed to the first feeding unit 13 by the drum 11 rotated by the drive unit 12 without diverging or becoming separated from the drum 11.

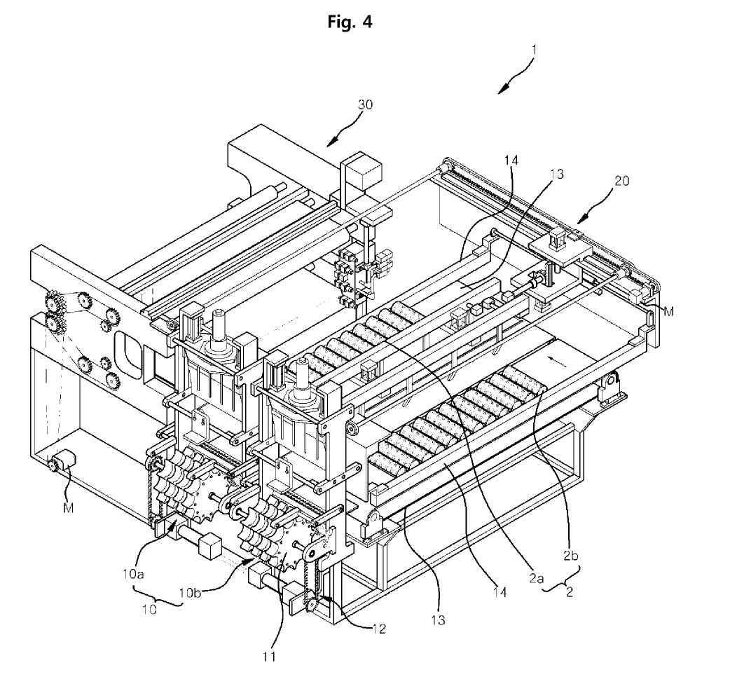

Both the transfer unit 20 and the setting unit 30 are adapted in a functional mattress producing device according to the second embodiment of the present invention in the same manner as that described for the first embodiment. The transfer unit 20 and the setting unit 30 will be described in detail with reference to FIG. 4 through FIG. 16, in which the functional mattress producing device according to the second embodiment of the present invention is illustrated.

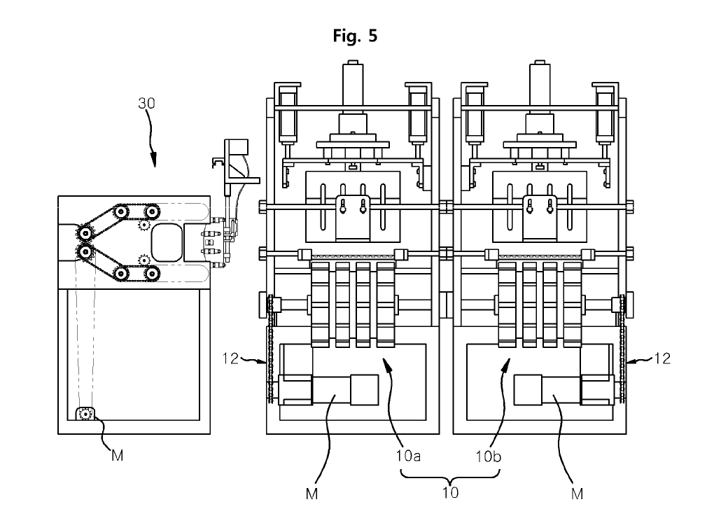

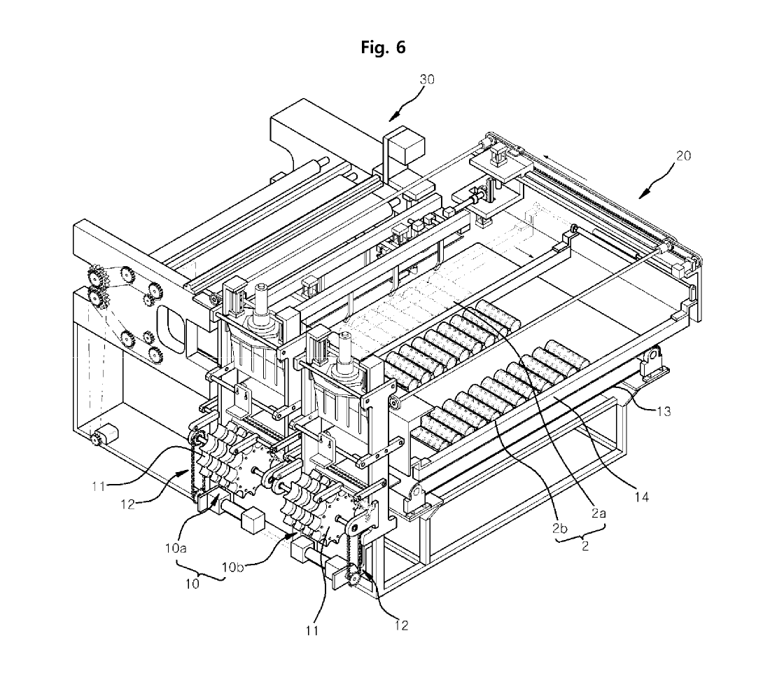

FIGS. 4 and 5 are a perspective view and a front view illustrating the functional pocket spring mattress producing device according to the second embodiment of the present invention. FIG. 6 is a perspective view illustrating the operation of the functional pocket spring mattress producing device according to the second embodiment of the present invention.

As shown in FIGS. 4 through 6, the supply unit 10 of the functional pocket spring mattress producing device 1 has a symmetrical structure and includes a first supply unit 10a and a second supply unit 10b. At locations outside each of the first and second supply units 10a and 10b, the first feeding unit 13 and the second feeding unit 14 are placed so that the pocket springs 2 can be stably fed to an inner central portion.

In the present invention, the first supply unit 10a and the second supply unit 10b are configured such that the first supply unit 10a supplies the first pocket springs 2a having the thick spring steel wire and the second supply unit 10b supplies the second pocket springs 2b having the thin spring steel wire.

It is preferred that the supply unit 10 be provided with a control unit (not shown) for controlling the operation of the supply unit 10 such that the first pocket springs 2a and the second pocket springs 2b supplied by the first supply unit 10a and the second supply unit 10b can be stably and alternately fed to the inner central portion.

Described in detail, in operation of the functional pocket spring mattress producing device 1, the first supply unit 10a supplies the first pocket springs 2a and the second supply unit 10b supplies the second pocket springs 2b according to a preset program stored in the control unit (not shown).

Further, the second supply unit 10b stops operating during the process in which the first supply unit 10a repeatedly supplies one or a plurality of first pocket springs 2a to the inner central portion under the control of the control unit (not shown) and, when the first supply unit 10a stops operating, the second supply unit 10b starts to operate and supply the second pocket springs 2b to the inner central portion.

While the second supply unit 10b supplies one or the plurality of second pocket springs 2b to the inner central portion, the first supply unit 10a stops operating under the control of the control unit (not shown).

Thereafter, when the second supply unit 10b stops operating, the first supply unit 10a starts once again to operate and to supply first pocket springs 2a to the inner central portion.

The reason that the first and second supply units 10a and 10b operate in alternation is because, when the first and second pocket springs 2a and 2b are simultaneously fed to the inner central portion by the first and second supply units 10a and 10b, the pocket springs 2a and 2b collide with each other.

Further, the alternating operation of the first and second supply units 10a and 10b can prevent the pocket springs 2 from becoming congested in the central portion due to the pocket springs 1 being overfed by the first and second supply unit 10a and 10b.

Thus, the functional pocket spring mattress producing device 1 of the present invention can repeatedly and regularly or repeatedly and irregularly supply one or a plurality of first pocket springs 2a to areas of the mattress on which the heavy parts of a user's body are laid, and can repeatedly and regularly or repeatedly and irregularly supply one or a plurality of second pocket springs 2b having higher cushion effects or higher cushioning performances than those of the first pocket springs 2a to other areas of the mattress on which the other parts of the user's body are laid.

When the first and second pocket springs 2a and 2b are repeatedly and alternately fed to the setting unit 30 as described above, the functional pocket spring mattress producing device 1 can produce a functional pocket spring mattress 3, as shown in FIG. 3.

Further, a user using the functional pocket spring mattress 3 can fall asleep easily and have a comfortable sleep and, further, can receive disease prevention effects because waist pain is relieved by the functionality of the pocket spring mattress 3.

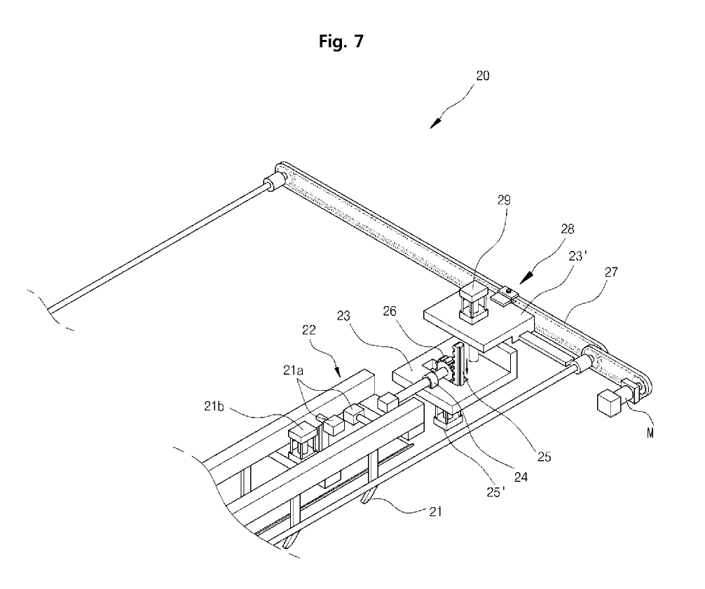

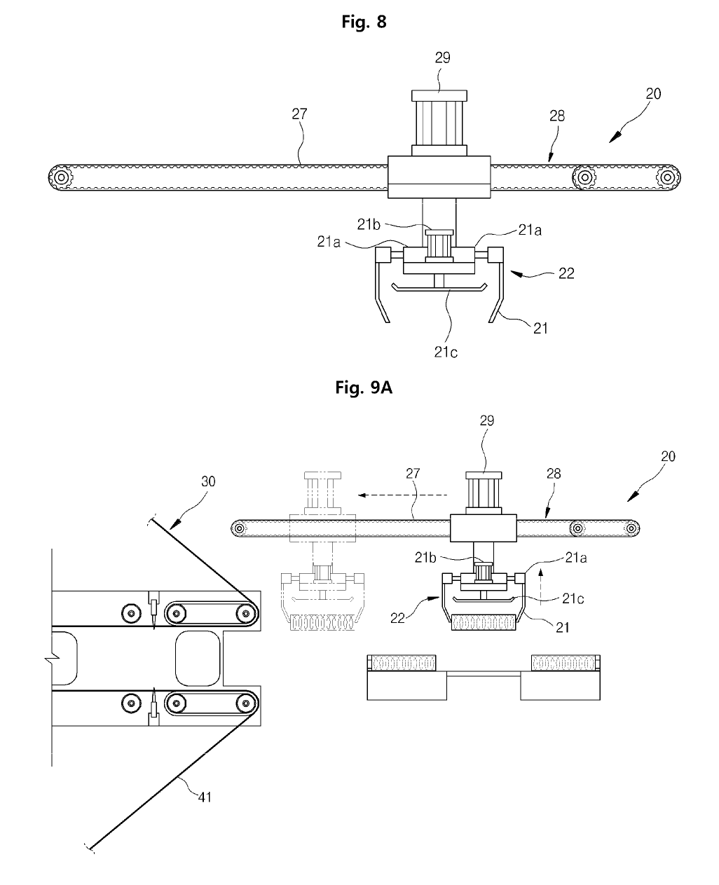

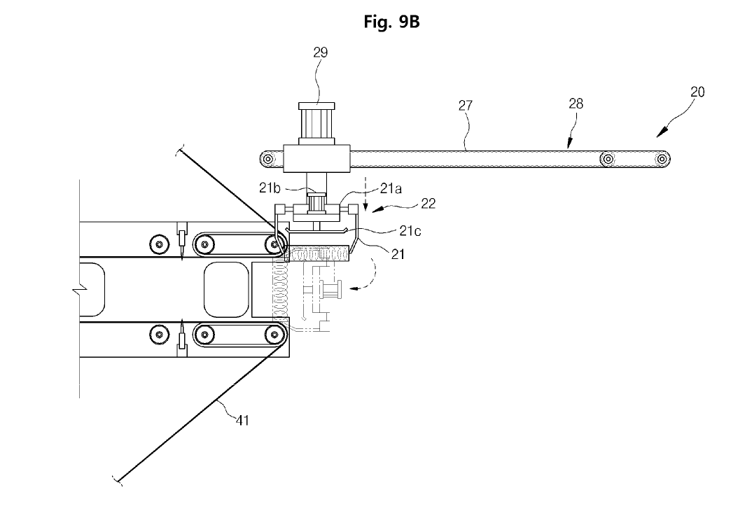

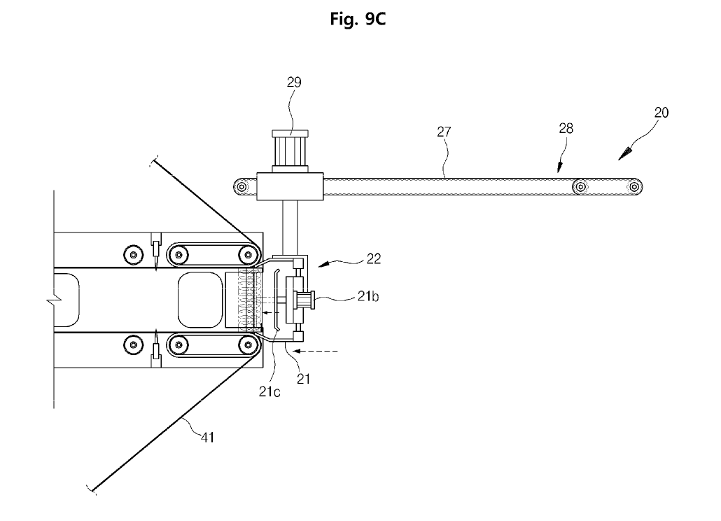

FIGS. 7 and 8 are a perspective view and a front view illustrating a transfer unit of the functional pocket spring mattress producing device according to the second embodiment of the present invention. FIGS. 9A, 9B and 9C are views illustrating the sequential operation of the transfer unit of the functional pocket spring mattress producing device according to the second embodiment of the present invention.

As shown in FIGS. 7, 8, 9A, 9B through 9C, the transfer unit 20 includes a transfer body 22, which has shafts in opposite ends thereof and a plurality of tongs 21 for holding the pocket springs 2. Each of the shafts of the transfer body 22 is held by a bearing 24 installed on the upper surface of a bracket 23. In the end of one shaft, both a rack 25 combined with a pneumatic cylinder 25′ at the lower end thereof and a pinion 26 are provided so that the transfer body 22 can be rotated in response to the rack 25 moving vertically. Further, the transfer body 22 can be moved to the left and right by reciprocators 28, which are provided at locations outside the ends of the two shafts and individually have a belt 27 wrapped around belt pulleys. The transfer body 22 also can be moved upwards and downwards by a pneumatic cylinder 29 installed at a location above the bracket 23.

Here, it is preferred that the reciprocators 28 be configured such that the transfer body 22 can be moved to the left and right between the pair of shafts by a drive motor M coupled to one of the two shafts.

To allow the transfer body 22 to be moved to the left and right along a guide rail provided below the belt 27, a guide member is provided on the lower surface of a support panel 23′. Further, a first belt pulley is mounted to the end of the shaft of the drive motor M, while a second belt pulley is mounted to the end of a shaft of the reciprocator 28, in which the drive motor M is coupled to the reciprocator 28 by a belt, so that the transfer body 22 can be moved to the left and right between the pair of shafts by the drive motor M.

Described in detail, in the functional pocket spring mattress producing device 1, the transfer body 22 can be moved upwards and downwards by the pneumatic cylinder 29 installed on the support panel 23′.

Further, when the rack 25 is moved upwards and downwards by a pneumatic cylinder 25′, the pinion 26 is rotated along with the transfer body 22.

Further, the transfer body 22 can be moved to the left and right along the guide rails by operation of the drive motor M and can hold the pocket springs 2 using the plurality of tongs 21.

Here, the transfer body 22 is preferably provided with a first pneumatic cylinder 21a for actuating the tongs 21. Further, a push plate 21c actuated by a second pneumatic cylinder 21b is preferably provided at a location inside the tongs 21 such that the push plate 21c can push the pocket springs 2 held by the tongs 21 into the setting unit 30.

In operation, the transfer unit 20 is moved down so as to hold the pocket springs 2 supplied by the supply unit 10 and holds the ends of the pocket springs 2 using the plurality of tongs 21 actuated by the first pneumatic cylinder 21a provided in the transfer body 22, and, thereafter, is moved upwards while holding the pocket spring 2.

Thereafter, the transfer unit 20 is moved by the reciprocator 28 in a direction perpendicular to the rows of the pocket spring units P constituting the pocket springs 2 and is moved downwards such that the transfer body 22 is located on the setting unit 30. When the transfer body 22 is located on the setting unit 30, the rack 25 is moved downwards by the pneumatic cylinder 25′ combined with the lower end of the rack 25, so that the pinion 26 is rotated along with the transfer body 22 at an angle of 90 degrees.

When the transfer body 22 is brought into a state horizontal to the setting unit 30, the second pneumatic cylinder 21b actuates the push plate 21c such that the push plate 21c pushes the pocket springs 2 into the setting unit 30.

After the transfer body 22 transfers the pocket springs 2 to the setting unit 30, the transfer body 22 is returned to an original position thereof so as to repeat the operation of transferring the pocket springs 2 to the setting unit 30, and thereafter, repeats the above-mentioned process of transferring the pocket springs 2 to the setting unit 30.

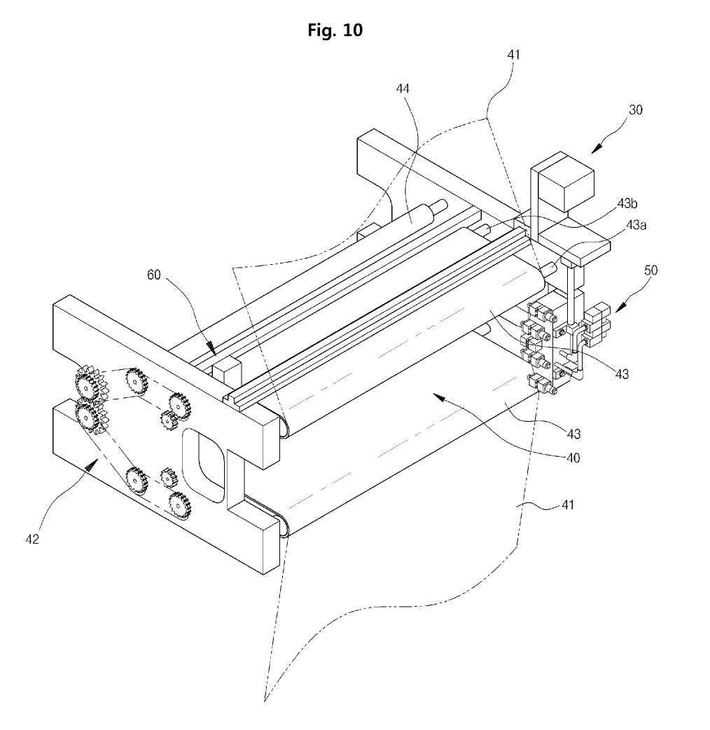

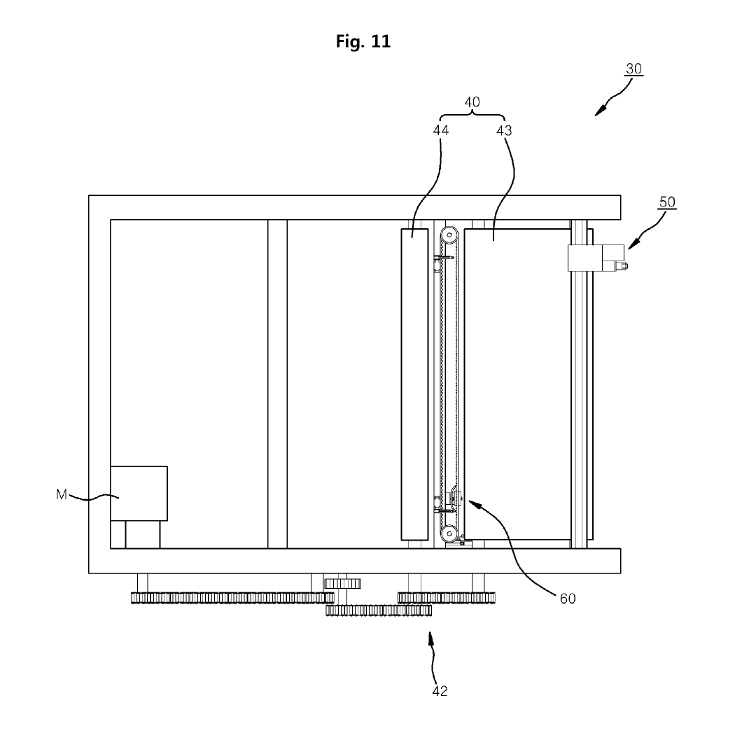

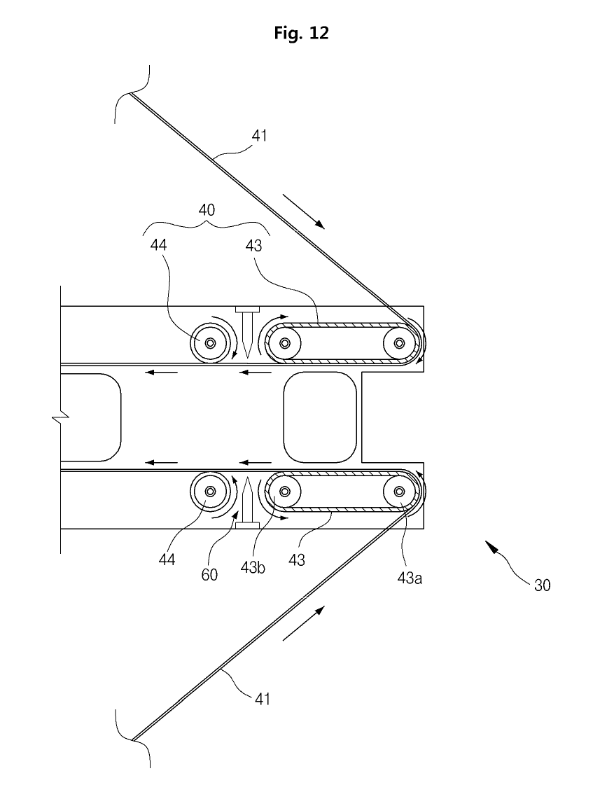

FIGS. 10 and 11 are a perspective view and a plane view illustrating the setting unit of the functional pocket spring mattress producing device according to the second embodiment of the present invention. FIG. 12 is a view illustrating the operation of a layering unit of the functional pocket spring mattress producing device according to the second embodiment of the present invention.

As shown in FIGS. 10 through 12, the setting unit 30 includes a layering unit 40, a spraying unit 50 and a cutting unit 60. The layering unit 40 supplies and adheres layering covers 41 to the upper and lower surfaces of the pocket springs 2 transferred by the transfer unit 20. The spraying unit 50 sprays an adhesive agent both to the layering covers 41 and to the pocket springs 2 such that the layering covers 41 supplied from the layering unit 40 can be adhered to the upper and lower surfaces of the pocket springs 2 transferred by the transfer unit 20, and the right ends of the existing pocket springs 2 can be adhered to the left ends of the next pocket springs 2 that are newly transferred by the transfer unit 20. The cutting unit 60 cuts the pair of layering covers 41 after a predetermined number of pocket springs 2 have been arrayed and adhered to each other by the spraying unit 50, thus fitting the covers to a mattress of a predetermined length L.

As described above, the functional pocket spring mattress producing device 1 operates such that the layering covers 41 for covering the upper and lower surfaces of the pocket springs 2 are supplied from the layering unit 40, and the spraying unit 50 adheres the right ends of the existing pocket springs 2 to the left ends of next pocket springs 2 newly transferred by the transfer unit 20.

Further, the spraying unit 50 sprays the adhesive agent both to the layering covers 41 and to the pocket springs 2 such that the layering covers 41 can be adhered to the upper and lower surfaces of the pocket springs 2.

When the layering covers 41 are adhered to the upper and lower surfaces of the predetermined number of pocket springs 2 arrayed to fit a mattress 3 of a predetermined length L as shown in FIG. 3, the pair of layering covers 41 are cut at a position around the right ends of the predetermined number of pocket springs 2, thus forming the desired functional pocket spring mattress 3.

The layering unit 40 includes a pair of conveyor belts 43 and a pair of rollers 44, which are combined with each other to form pairs. The pairs of conveyor belts 43 and rollers 44 are actuated by a drive unit 42 such that the layering covers 41 can be fed to the rollers 44 under the guide of the inside parts of the rotating conveyor belts 43.

In other words, in each of the conveyor belts 43 of the layering unit 40, first and second rollers 43a and 43b are held by respective bearings and are coupled to each other by a belt. A single gear is provided on an end of a shaft of the first roller 43a, while a double gear is provided on an end of a shaft of each roller 44. The inside gear of the double gear provided on the roller 44 is coupled to the gear provided on the shaft of the second roller 43b by a chain.

Further, two double gears are provided at locations, which are aligned with the middle position between the two rollers 44 while being offset from the two rollers 44. The inside gears of the two double gears offset from the rollers 44 are engaged with each other, so that the two double gears can be rotated at the same time. Further, the outside gears of the two double gears offset from the rollers 44 are coupled to the outside gears of the double gears provided on the shafts of the two rollers 44 by respective chains.

Here, the drive motor M may be installed around the shaft of one of the two rollers 44 and may be directly connected thereto. Alternatively, a gear may be provided on the shaft of one of the two double gears offset from the rollers 44, another gear may be provided on the shaft of the drive motor M, and the two gears may be coupled to each other by a chain.

Therefore, the conveyor belts 43 and the rollers 44 can be rotated at the same time by the drive motor M.

When the drive motor M of the functional pocket spring mattress producing device 1 is rotated counterclockwise, the conveyor belts 43 and the rollers 44 are rotated counterclockwise at the same time, so that the layering covers 41 and the pocket springs 2 supplied into the layering unit 40 are fed to the rollers 44 under the guide of the inside parts of the rotating conveyor belts 43.

Therefore, the pocket springs 2 supplied under the guide of the pair of conveyor belts 43 are arrayed in lateral directions and are fed to the pair of rollers 44.

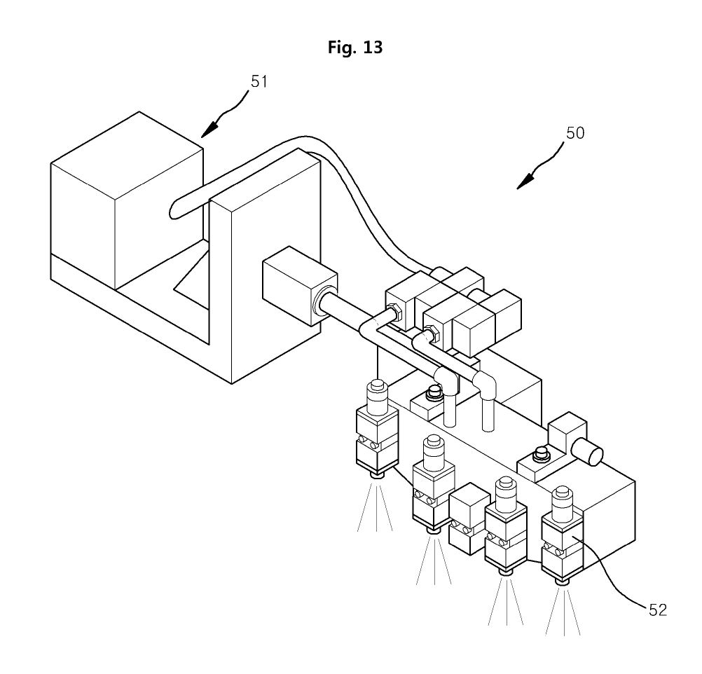

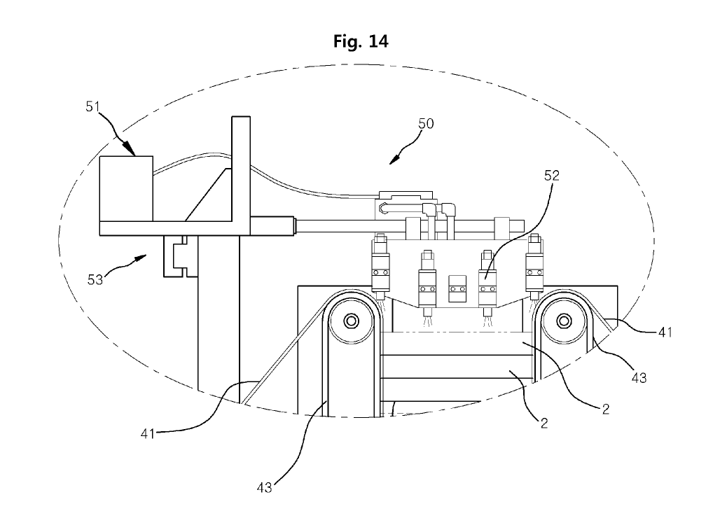

FIGS. 13 and 14 are a perspective view of the spraying unit 30 of the functional pocket spring mattress producing device 1 according to the second embodiment of the present invention, and a view illustrating the operation of the spraying unit 30.

As shown in FIGS. 13 and 14, the spraying unit 50 includes a main body 51 for supplying an adhesive agent, a plurality of spray nozzles 52 for spraying the adhesive agent supplied from the main body 51 to both the pocket springs 2 and the layering covers 41, and a carrier 53 carrying the spray nozzles 52 and moving the spray nozzles 52 such that the spray nozzles 52 spray the adhesive agent onto both the pocket springs 2 and the layering covers 41.

The carrier 53 preferably includes a guide rail, which is mounted on the lower surface of the main body 51, and a guide member, which is provided at a predetermined location below the main body 51 such that the spraying unit 50 can move along the guide rail.

The spraying unit 50 can evenly spray the adhesive agent both onto the pair of layering covers 41 fed by the pair of conveyor belts 43 and onto the end surfaces of the pocket springs 2, so that the layering covers 41 can be securely adhered to the upper and lower surfaces of the pocket springs 2 without undesirably separating therefrom.

Further, the layering covers 41 can be adhered in a lateral direction to next pocket springs 2 newly supplied by the supply unit 10.

It is preferred that the spraying unit 50 be configured to primarily spray the adhesive agent while moving forwards under the guide of the guide rail and to secondarily spray the adhesive agent while being returned to its original position. Alternately, the spraying unit 50 may be configured to spray the adhesive agent only when it moves in one direction.

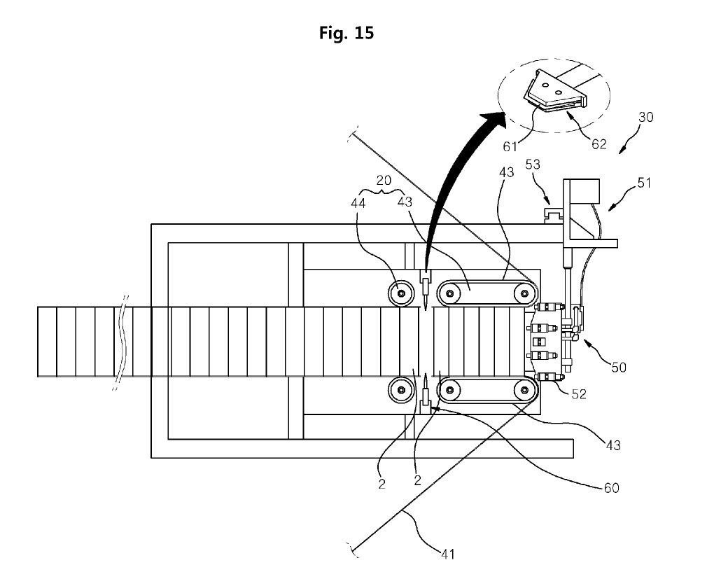

FIG. 15 is a view illustrating the operation of a setting unit of the functional pocket spring mattress producing device according to the second embodiment of the present invention.

As shown in FIG. 15, the transfer unit 20 is provided with a control unit (not shown). The control unit stores therein a preset number of the pocket springs 2 to be fed to the layering unit 40, so that, when the predetermined number of pocket springs 2 has been arrayed in the layering unit 40, the control unit stops the operation of the transfer unit 20 for a predetermined period of time.

This is because of the fact that, to cut the layering covers 41 placed around the ends of a predetermined number of pocket springs 2 arrayed to fit a predetermined length L of a desired mattress shown in FIG. 3 using the cutting unit 60, it is required to use an additional fixing unit or an additional fixing device to hold or fix the layering covers 41 placed around the ends of the predetermined number of arrayed pocket springs 2.

However, the functional pocket spring mattress producing device 1 of the present invention forms a space between a predetermined number of previously arrayed pocket springs 2 and a predetermined number of newly arrayed pocket springs 2, thus compressing and securely holding the pair of layering covers 41 placed between the rear end pocket springs 2 of the predetermined number of previously arrayed pocket springs 2 and the front end pocket springs 2 of the predetermined number of newly arrayed pocket springs 2, using both the pair of conveyor belts 43 and the pair of rollers 44.

Further, the cutting unit 60 cuts the layering covers 41, which are placed around the ends of the predetermined number of layered pocket springs 2.

Described in detail, when a predetermined number of pocket springs 2 has been arrayed in the space between the pair of conveyor belts 43 and the pair of rollers 44, the transfer unit 20 of the functional pocket spring mattress producing device 1 stops operation thereof under the control of the control unit (not shown) for a predetermined lengthy period of time in which the transfer unit 20 may transfer the pocket springs 2 once, twice or three times. However, the drive unit 42 in the above state is continuously rotated without interruption.

When the transfer unit 20 restarts its operation of newly transferring a predetermined number of pocket springs 2 under the control of the control unit (not shown) after the predetermined period of time in which the transfer unit 20 may transfer the pocket springs 2 once, twice or three times has elapsed, a space capable of accommodating one, two or three pocket springs 2 is defined between the pair of conveyor belts 43 and the pair of rollers 44 or between the rear ends of the previously arrayed pocket springs 2 and the front ends of the newly arrayed pocket springs 2.

The space, in which only the layering covers 41 are present, is defined between the conveyor belts 43 and the rollers 44. Thus, the cutting unit 60 can cut the layering covers 41.

When the functional pocket spring mattress producing device 1 repeats the above-mentioned process, the device 1 can repeatedly produce functional pocket spring mattresses 3 of FIG. 3.

Further, as shown in FIG. 15, the cutting unit 40 includes a cutter 62, which has a blade 61 and is installed in a space defined between the conveyor belts 43 and the rollers 44.

The functional pocket spring mattress producing device 1 operates such that the cutting unit 40 can cut the layering covers 41 placed in the space defined between the conveyor belts 43 and the rollers 44.

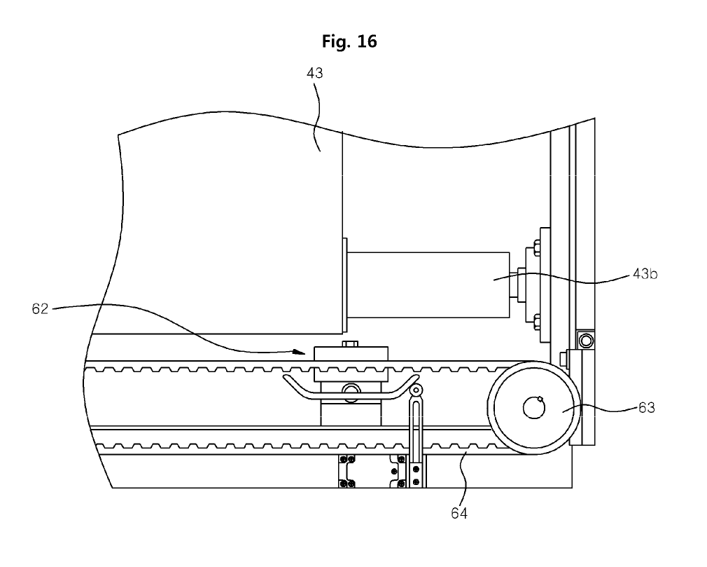

FIG. 16 is a partially enlarged view illustrating the operation of a cutter of the functional pocket spring mattress producing device according to the second embodiment of the present invention.

As shown in FIG. 16, the cutter 62 is fixed to the upper surface of the belt 64 wrapped around the belt pulleys 63, so that the cutter 62 can reciprocate forwards and backwards in a space defined between the pair of conveyor belts 43 and the pair of rollers 44.

Here, the belt 64 preferably uses a timing belt.

In the functional pocket spring mattress producing device 1, the cutter 62 moves forwards and backwards because of the rotation of the belt pulleys 63 and cuts the layering covers 41 placed in the space between the conveyor belts 43 and the rollers 44.

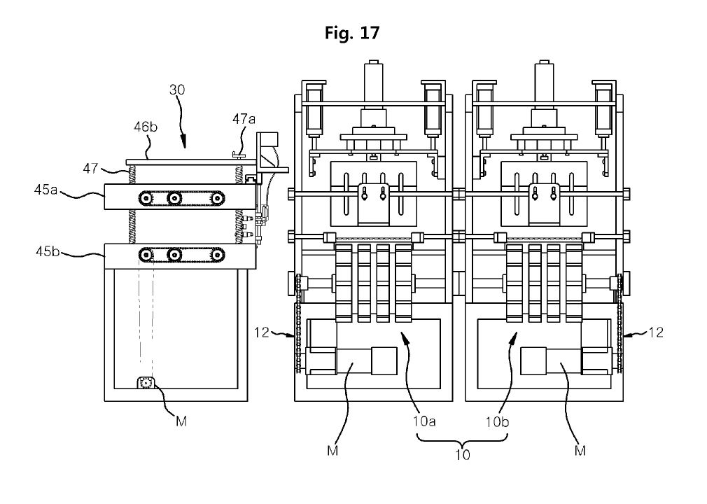

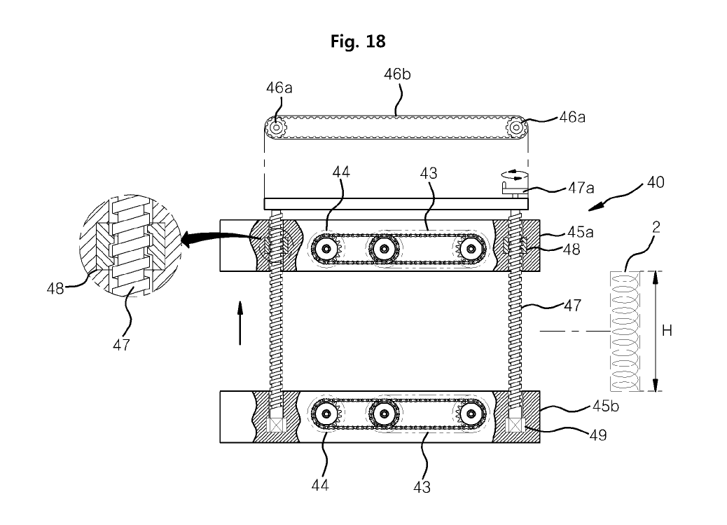

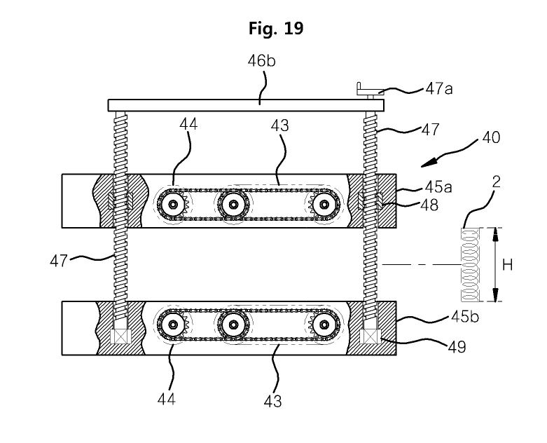

FIG. 17 is a front view illustrating a functional pocket spring mattress producing device according to a third embodiment of the present invention. FIGS. 18 and 19 are views illustrating the operation of a layering unit 40 of the functional pocket spring mattress producing device according to the third embodiment of the present invention.

As shown in FIGS. 17 through 19, the layering unit 40 of the functional pocket spring mattress producing device 1 includes a first frame 45a and a second frame 45b, which have respective conveyor belts 43 and respective rollers 44 on front and rear surfaces thereof. The first and second frames 45a and 45b are combined with each other by a pair of screw drive shafts 47 such that the interval between the first frame 45a and the second frame 45b can be adjusted by the screw drive shafts 47 rotating.

The second frame 45b is embedded with bearings 49, while the first frame 45a is embedded with screw drive members 48. Further, the upper ends of the pair of screw drive shafts 47 are provided with respective belt pulleys 46a which are coupled to each other by a belt 46b. Further, one end of a screw drive shaft 47 is preferably provided with a drive handle 47a, which can move the first frame 45a upwards or downwards when it rotates and thereby can adjust the interval between the first frame 45a and the second frame 45b.

In other words, when the drive handle 47a is rotated clockwise according to the height of the pocket springs 2 transferred by the transfer unit 20, the pair of drive shafts 47 are idle-rotated in their places and, at the same time, the first frame 45a can be moved upwards by the drive member 48 installed therein.

On the contrary, when the drive handle 47a is rotated counterclockwise, the pair of drive shafts 47 are idle-rotated in their places and, at the same time, the first frame 45a can be moved downwards by the drive member 48 installed therein.

Due to the above-mentioned layering unit 40, functional pocket spring mattresses 3 having different heights H as shown in FIG. 3 can be produced.

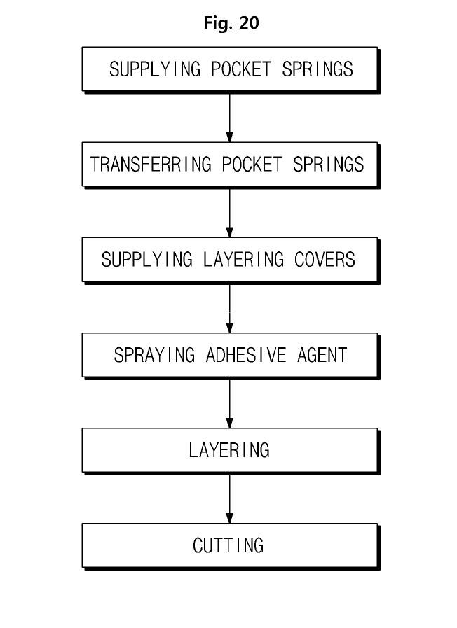

FIG. 20 is a block diagram illustrating the process of a functional pocket spring mattress production method according to the present invention.

As shown in FIG. 20, the pocket spring mattress production method of the present invention includes: a pocket spring supplying operation for supplying first and second pocket springs 2a and 2b having different spring steel wire diameters using a first supply unit 10a and a second supply unit 10b, a transferring operation for transferring the pocket springs 2 supplied in the pocket spring supplying operation, a layering cover supplying operation for supplying layering covers 41 so as to adhere the layering covers 41 to upper and lower surfaces of the pocket springs 2 transferred in the transferring operation, an adhesive agent spraying operation for spraying an adhesive agent both to the pocket springs 2 and to the layering covers 41 supplied in the layering cover supplying operation, a layering operation for adhering the layering covers 41 to the upper and lower surfaces of the pocket springs 2 supplied in the pocket spring supplying operation, and a cutting operation for cutting ends of a predetermined number of pocket springs 2 which have been arrayed in the layering operation and in which the layering covers 41 have been adhered to the upper and lower surfaces of the arrayed pocket springs 2.

In the functional pocket spring mattress producing method of the present invention, when the supply unit 10 repeatedly and sequentially supplies the first and second pocket springs 2a and 2b having different spring steel wire diameters in a way such that regular or irregular numbers of first and second pocket springs 2a and 2b can be repeatedly supplied, the transfer unit 20 transfers the pocket springs 2 to the setting unit 30.

The setting unit 30 supplies the layering covers 41 for covering the upper and lower surfaces of the pocket springs 2 fed thereto and sprays the adhesive agent onto both the pocket springs 2 and to the layering covers 41.

Thereafter, when the layering covers 41 placed around the ends of the predetermined number of arrayed pocket springs 2 are cut, a desired functional pocket spring mattress 3, in which the predetermined number of pocket springs 2 is arrayed as shown in FIG. 3, can be produced.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A device for producing functional pocket spring mattresses, in which a predetermined number of pocket springs each prepared by connecting a predetermined number of pocket spring units to each other in the form of a band are arrayed to fit a desired predetermined size of a bed mattress, the pocket spring mattress producing device comprising:
a supply unit for supplying the pocket springs;
a transfer unit for transferring the pocket springs supplied by the supply unit; and
a setting unit for setting the pocket springs transferred by the transfer unit, thus producing a functional pocket spring mattress.

2. The device for producing functional pocket spring mattresses as set forth in claim 1, wherein the supply unit comprises:
a toothed drum having a plurality of holding grooves for holding the pocket springs;
a drive unit for rotating the drum;
a first feeding unit for feeding the pocket springs supplied by the drum; and
a second feeding unit for feeding the pocket springs held on the first feeding unit in a direction perpendicular to a moving direction of the first feeding unit.

3. The device for producing functional pocket spring mattresses as set forth in claim 1, wherein the transfer unit comprises:
a transfer body having shafts in opposite ends thereof and a plurality of tongs for holding the pocket springs, each of the shafts being held by a bearing installed on an upper surface of a bracket;
a rack and a pinion provided at locations around an end of one of the shafts of the transfer body such that the transfer body can be rotated in response to the rack moving vertically, the rack being combined at a lower end thereof with a pneumatic cylinder;
a reciprocator for moving the transfer body to the left and right, the reciprocator being provided at a location outside the ends of the shafts of the transfer body and having a belt wrapped around belt pulleys; and
a pneumatic cylinder installed at a location above the bracket and moving the transfer body upwards and downwards.

4. The device for producing functional pocket spring mattresses as set forth in claim 3, wherein the transfer body further comprises:
a first pneumatic cylinder for actuating the tongs; and
a push plate provided at a location inside the tongs such that the push plate can push the pocket springs held by the tongs into the setting unit, the push plate being actuated by a second pneumatic cylinder.

5. The device for producing functional pocket spring mattresses as set forth in claim 2, wherein the setting unit comprises:
a layering unit for supplying and adhering layering covers to upper and lower surfaces of the pocket springs transferred by the transfer unit;
a spraying unit for spraying the adhesive agent both to the layering covers and to the pocket springs such that the layering covers supplied from the layering unit can be adhered to the upper and lower surfaces of the pocket springs transferred by the transfer unit, and right ends of the existing pocket springs can be adhered to left ends of next pocket springs newly transferred by the transfer unit; and
a cutting unit for cutting the layering covers at ends of a predetermined number of pocket springs arrayed and adhered to each other by the spraying unit, thus fitting the layering covers to a mattress of a predetermined length.

6. The device for producing functional pocket spring mattresses as set forth in claim 5, wherein the layering unit comprises:
a pair of conveyor belts and a pair of rollers combined with each other in pairs, the pairs of conveyor belts and rollers being actuated by a drive unit such that the pocket springs can be fed to the rollers while being guided by inside parts of the rotating conveyor belts.

7. The device for producing functional pocket spring mattresses as set forth in claim 6, wherein the layering unit further comprises:
a first frame and a second frame having respective conveyor belts and respective rollers on front and rear surfaces thereof, the first and second frames being combined with each other by a screw drive shaft such that an interval between the first and second frames can be adjusted by rotating the screw drive shaft.

8. The device for producing functional pocket spring mattresses as set forth in claim 5, wherein the spraying unit comprises:
a main body for supplying the adhesive agent;
a plurality of spray nozzles for spraying the adhesive agent supplied from the main body onto both the pocket springs and the layering covers; and
a carrier for carrying the spray nozzles and moving the spray nozzles such that the spray nozzles can spray the adhesive agent onto both upper surfaces of the pocket springs and to upper surfaces of the layering covers in a direction from one end to another end.

9. The device for producing functional pocket spring mattresses as set forth in claim 5, wherein the cutting unit comprises:
a cutter having a blade and installed in a space defined between the conveyor belts and the rollers.

10. A method for producing functional pocket spring mattresses, in which a predetermined number of pocket springs each prepared by connecting a predetermined number of pocket spring units to each other in the form of a band are arrayed to fit a bed mattress of a predetermined size, the pocket spring mattress producing method comprising:
a pocket spring supplying operation for supplying first and second pocket springs having different spring steel wire diameters using first and second supply units;
a transferring operation for transferring the pocket springs supplied in the pocket spring supplying operation;
a layering cover supplying operation for supplying layering covers so as to adhere the layering covers to upper and lower surfaces of the pocket springs transferred in the transferring operation;
an adhesive agent spraying operation for spraying an adhesive agent onto both the pocket springs and the layering covers supplied in the layering cover supplying operation;
a layering operation for adhering the layering covers to the upper and lower surfaces of the pocket springs supplied in the pocket spring supplying operation; and
a cutting operation for cutting ends of a predetermined number of pocket springs which has been arrayed in the layering operation and in which the layering covers have been adhered to the upper and lower surfaces of the arrayed pocket springs.
